(19) United States
(12) Patent Application Publication
(10) Pub. No.: US 2011/0244173 A1
(43) Pub. Date: Oct. 6, 2011

(54) AIR-PERMEABLE CUSHIONING FLOOR MAT

(76) Inventor: MING-SHUN YANG, Taipei (TW)

(21) Appl. No.: 12/753,079

(22) Filed: Apr. 1, 2010

(51) Int. Cl. B32B 5/26; B32B 5/02; B32B 27/00; B32B 27/30

(52) U.S. Cl. 428/92; 428/95; 428/100; 428/309.9

(57) ABSTRACT

An air-permeable cushioning floor mat includes a top surface layer, a middle air permeation layer, and a bottom anti-skid layer. The surface layer can be of various variations, including being made of carpet like materials, fabric like materials, or plastic materials. For fabric like materials, knit fabrics and brushed knit fabric can be used. For plastic materials, thermoplastic elastomer, thermoplastic rubber, or polyvinyl chloride can be used. The surface layer is bonded to the air permeation layer. The air permeation layer includes upper and lower netting portions between which multiple tiny and stiff synthetic fiber yarns are interposed. The anti-skid layer is bonded to the underside of the air permeation layer and the anti-skid layer includes a loop-and-hook type anti-skidding material. As such, the mat offers the advantages of comfortableness, resilient cushioning, and tiredness removal and shows excellent effects of air permeation and skidding resistance.

### (a) TECHNICAL FIELD OF THE INVENTION

The present invention generally relates to an air-permeable cushioning floor mat for automobiles, which is suitable for use as an in-automobile carpet or a household carpet to maintain a normal condition of the floor mat for effects of air permeation, ventilation, and mildew resistance, whereby when being laid on an indoor carpet, the mat provides the advantages of comfortableness, resilient cushioning, and tiredness removal, and the underside of the mat shows an effect of anti-skidding through loop-and-hook type coupling to resist skidding of foot treading, and the mat may also serve as a sleep mat for a pet and offers the functions of comfortableness, cushioning, air permeation and ventilation for reducing foul smell of the pet mat.

### (b) DESCRIPTION OF THE PRIOR ART

A floor mat is often provided with an anti-skid structure on the underside thereof, such as spike-like plastic material, to resist undesired skidding. However, the plastic material that carries the spikes is air impermeable.

On the other hand, while an in-automobile mat is laid on a floor of an automobile, humidity or water vapor may be trapped on the underside of the floor mat due to rainwater penetrating between the floor mat and an in-automobile carpet. When excessive humidity is kept under the floor mat, foul smell may be induced.

Further, for a pet sleep mat on which a pet may lie, the pet often generate sweats and the sweats may stain the mat. When the mat is of insufficient air permeability, foul smells caused by the sweats may be accumulated in the mat, making the surrounding full of the foul smell.

To overcome the above discussed problems that would occur to the conventional floor mat or pet sleep mat, the present invention provides a mat that is composed of three layers of materials, including a surface layer made of fabric materials or plastic material, a middle layer serving as an air permeation and cushioning layer, and an underside anti-skidding layer; the mat as a whole provides the effects of air permeation, resilient cushioning, and skidding resistance.

Further, a housewife often has to stand for a long time when cooking. The body weight is almost born by the foot soles. The present invention provides a floor mat that can be made with an increased thickness and a middle air permeation layer that shows an effect of resilient cushioning. Thus, the floor mat of the present invention provides an excellent effect of relaxing foot soles and reducing tiredness.

Thus, the present invention provides a floor mat that features air permeation, cushioning, and skidding resistance and that is fit for mass production and has a sense of lightweight and simple construction.

### SUMMARY OF THE INVENTION

A primary objective of the present invention is to provide an air-permeable cushioning floor mat, which shows improved air permeation, comfortableness, and cushioning of the mat itself and provides an effect of skidding resistance.

Another objective of the present invention is to provide an air-permeable floor mat, which does not cause permanent damage or fuzzing on a carpet and has the advantages of simple components, easy manufacturing, low manufacturing costs, excellent durability, and good comfortableness, so that when foot soles are on the mat, the foot soles feel soft contact that helps eliminating the tiredness caused by long standing and the mat also offers sufficient air permeation and excellent resilient cushioning.

A further objective of the present invention is to provide an air-permeable cushioning floor mat, which may serve as a pet mat and which shows excellent comfortableness in view of the increased thickness and excellent air permeability, so that the pet can feel more comfortable when it is lying on the mat and foul smells caused by sweats of the pet absorbed in the mat can be reduced.

To achieve the above objectives, the present invention provides an air-permeable cushioning floor mat, which is composed of a surface layer set on the top side, an air permeation layer set in the middle, and an anti-skid layer set in the bottom side, which are assembled together to form a mat of excellent air permeability. The middle air permeation layer comprises an upper netting portion, a lower netting portion and rigid synthetic fiber yarns that are interposed between thee upper and lower netting portions. The rigid synthetic fiber yarns can be arranged to show a desired vertical dimension so as to provide resiliency. The bottom-side anti-skid layer may comprise a loop-and-hook type anti-skidding material, comprising a plurality of tiny and rigid synthetic fiber yarns, which can be easily engaged with a carpet to resist skidding and which cause no damage to the carpet when being separated therefrom, so that the anti-skid layer, as a whole, shows excellent effect of anti-skidding. The middle air permeation layer comprises a lining material that shows a sufficient thickness or vertical dimension to provide effects of comfortable feeling, cushioning, and pressure relief to foot soles stepping thereon.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a floor mat according to a preferred embodiment of the present invention.

FIG. 2 is a magnified view of an air permeation layer of the floor mat according to the present invention.

FIG. 3 is a perspective view of the floor mat according to the present invention.

FIG. 4 is a cross-sectional view of the floor mat shown in FIG. 3.

FIG. 5 is a partially magnified view of the floor mat of FIG. 4.

### DETAILED DESCRIPTION OF THE PREFERRED EMBODIMENTS

The following descriptions are exemplary embodiments only, and are not intended to limit the scope, applicability or configuration of the invention in any way. Rather, the following descriptions provide a convenient illustration for implementing exemplary embodiments of the invention. Various changes to the described embodiments may be made in the function and arrangement of the elements described without departing from the scope of the invention as set forth in the appended claims.

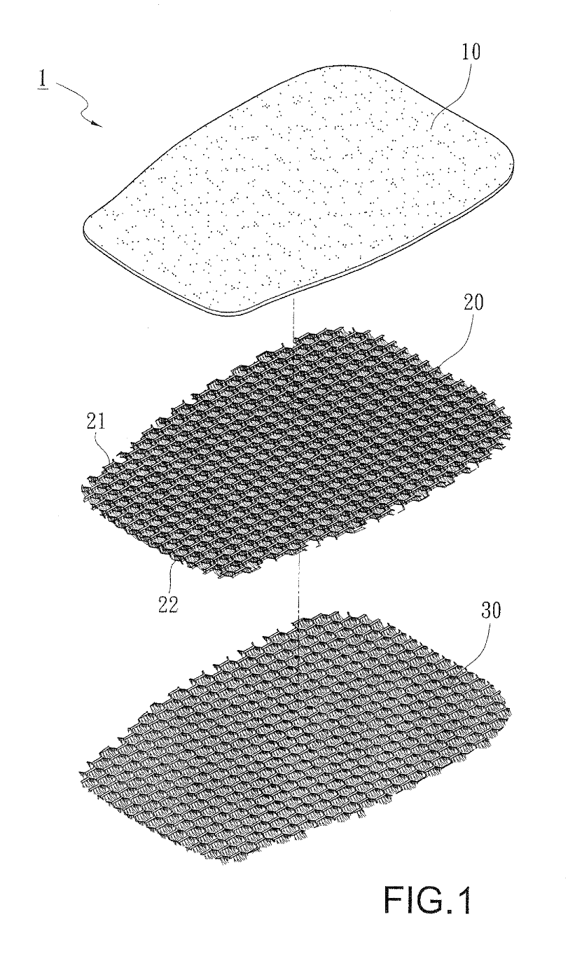

Referring to FIG. 1, the present invention provides an air-permeable cushioning floor mat 1, which is composed of three layers of materials, including a surface layer 10 set on the top side, an air permeation layer 20 set on the middle, and an anti-skid layer 30 fixed on the bottom side. The top-side surface layer 10 can be of variation, including being formed of a carpet material, a fabric material, or a plastic material. The carpet material can be, for example, a needle punched carpet or a tufted carpet, depending on the application thereof. For a surface layer made of a fabric, it can be a knit fabric or a brushed knit fabric. For a surface layer made of a plastic material, it can be, for example, thermoplastic elastomer (TPE), or thermoplastic rubber (TPR), or polyvinyl chloride (PVC). For a surface layer made of TPE, TPR, or PVC, the surface layer can be formed through extrusion lamination or alternatively, the surface layer is made to be a thin flat board to facilitate the surface layer to be bonded to the middle air permeation layer 20 in the subsequent processing. When the surface layer is made of a plastic material, the thin flat board so made can be perforated to form apertures therein. After the surface layer 10 is bonded to the air permeation layer 20, adhesives are applied to an underside of the air permeation layer 20 for bonding to the bottom-side anti-skid layer 30.

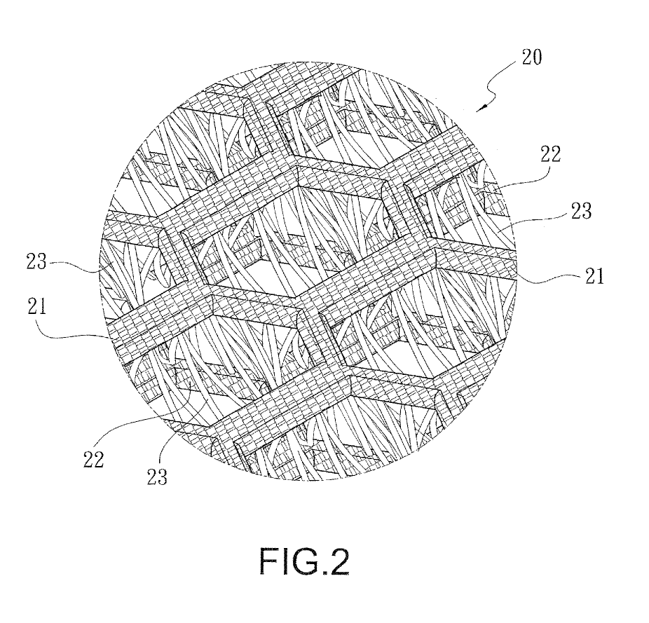

Referring to FIG. 2, the middle air permeation layer 20 is constructed to comprise an upper netting portion 21, a lower netting portion 22, and a rigid layer of synthetic fiber yarns 23 of single filament interposed between the upper and lower netting portions (21, 22). The lower netting portion 22 possesses predetermined netting meshes, which have a density and size as desired to allow the air permeation layer 20 to provide desired air permeability. For example, for large meshes, improved air permeation in both vertical and horizontal directions can be realized. Further, when the meshes of the lower netting portion 22 are in small size, improved air permeation in the horizontal direction can be achieved. The air permeation layer 20, as a whole, provides the underside of the surface layer 10 with the feature of humidity resistance and air permeation and also offers an advantage of resilient cushioning realized through the air permeation layer 20 itself.

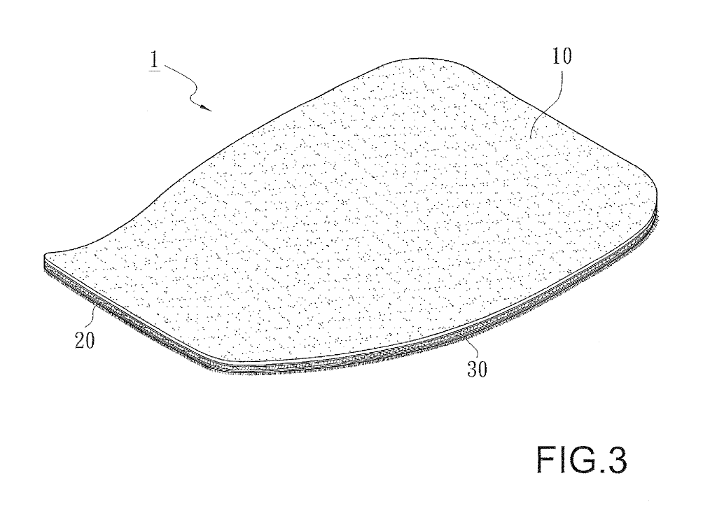

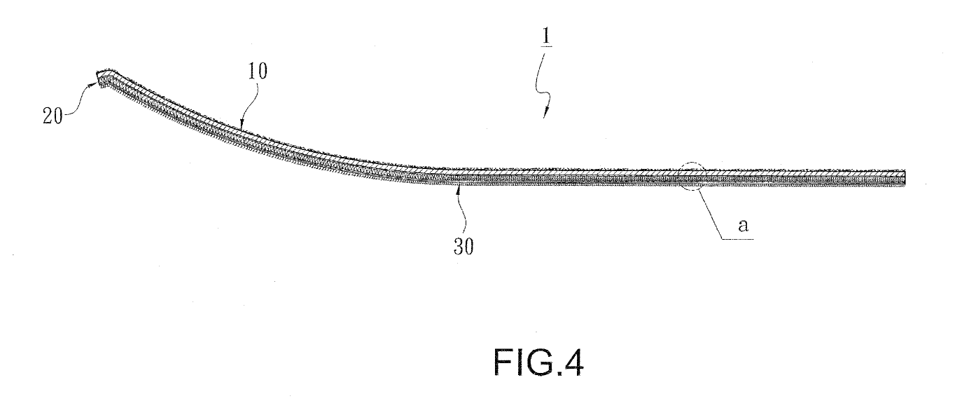

Referring to FIGS. 3 and 4, after the top-side surface layer 10 and the middle permeation layer 20 are bonded together, the bonded layers are wound around a reel and a coating device is employed to apply a layer of adhesive to the underside of the air permeation layer 20 for bonding to the anti-skid layer 30. As such, the anti-skid layer 30 is bonded to the lower netting portion 22 of the air permeation layer 20, and the whole air-permeable cushioning floor mat 1 can show improved natures of resiliency, cushioning, and air permeation due to the air permeation layer 20 being composed of an upper netting portion 21, a lower netting portion 22, and a layer of rigid synthetic fiber yarns 23 that is arranged between the two netting portions. Alternatively, the middle air permeation layer 20 can be sewed to the anti-skid layer 30, and then the upper side of the air permeation layer 20 is adhered to the top-side surface layer 10 to combine said three layers into one.

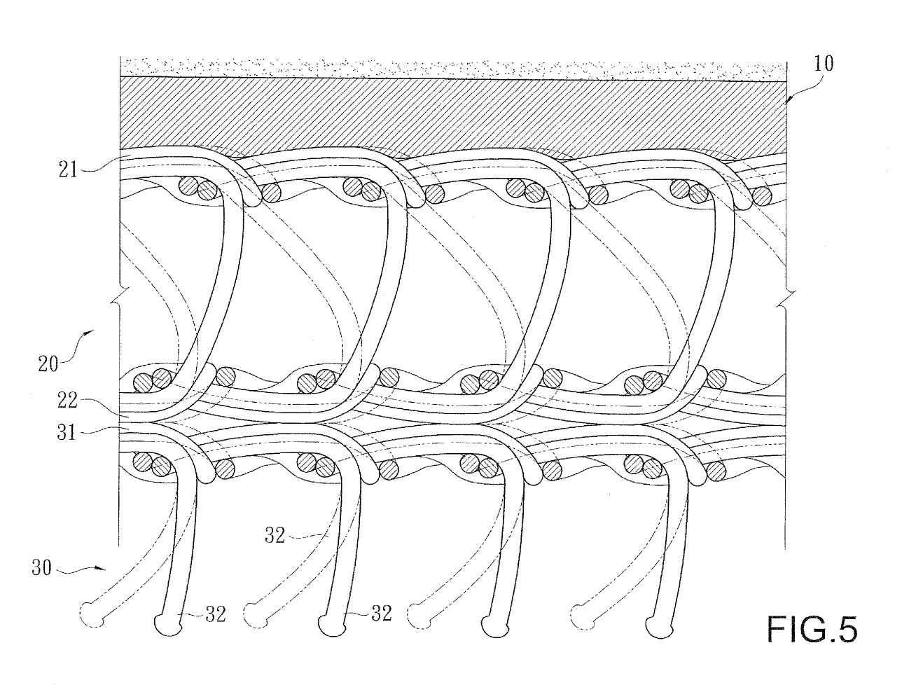

Referring FIG. 5, in the instant embodiment, the air-permeable cushioning floor mat 1 is composed of three layers of materials, including a surface layer 10 set on the top side, an air permeation layer 20 set on the middle, and an anti-skid layer 30 fixed on the bottom side. The surface layer 10 can be made of a carpet material, a fabric material, or a plastic material. When carpet material is used, the carpet material can be, for example, a needle punched carpet or a tufted carpet. When a fabric material is used, it can be a knit fabric or a brushed knit fabric. When a plastic material is used, it can be, for example, thermoplastic elastomer (TPE), or thermoplastic rubber (TPR), or polyvinyl chloride (PVC). When the floor mat is used as a household floor mat, improved anti-skidding characteristics are required for a household carpet, so that the anti-skid layer 30 can be embodied as a loop-and-hook type anti-skidding material, of which the construction comprises an upper knitted portion 31 and projecting rigid synthetic fiber yarns 32, whereby the projecting rigid synthetic fiber yarns 32 formed on the bottom of the hoop-and-hook type anti-skidding material can be used to engage a carpet in a loop-and-hook fashion without causing permanent damage or fuzzing of the carpet.

For a surface layer 10 made of a knit fabric or a brushed knit fabric, it is bonded to the topmost location of the air permeation layer 20 and the anti-skid layer 30 and may serve as a sleep mat for a pet, whereas the soft fabric, such as the brushed knit fabric, is contacted with the pet and makes the pet feeling comfortable. Further, as the air permeation layer 20 on the underside of the surface layer 10 comprises rigid synthetic fiber yarns 23 that make a vertical dimension, providing a comfortable sense of the surface through the thick mat showing resiliency and softness, relief of foot soles pressure for long standing can be released, and thereby eliminating tiredness of the feet. The anti-skid layer 30 bonded to the bottommost side provides an anti-skidding effect on the floor at home or in an automobile. Thus, a pet, when lying on the mat, may experience improved comfortableness and air permeability. In view of the improved air permeability achieved through the air permeation layer on the lower side of the mat, foul smells of pets caused by sweating can be easily eliminated to greatly improve the environment for keeping pets.

To summarize, the floor mat according to the present invention comprises an air permeation layer, which is set in the middle and shows the characteristics of softness and light-weight, and possessing the advantages of high air permeation and cushioning effects, whereby the floor mat so manufactured as a product can show excellent characteristics of air permeation and skid resistance.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An air-permeable cushioning floor mat, comprising a surface layer that is set in a top side, an air permeation layer that is set in the middle, and an anti-skid layer that is set in a bottom side, characterized in that:
the surface layer is set on a topmost side for being treaded by foot soles;
the air permeation layer shows effects of resiliency, cushioning, and air permeation, comprising an upper netting portion and a lower netting portion, and rigid synthetic fiber yarns which are interposed between the upper and lower netting portions for supporting purposes; the upper netting portion is bonded to the surface layer, and the lower netting portion is bonded to the anti-skid layer; and
the anti-skid layer provides an effect of anti-skidding, being bonded to the lower netting portion of the air permeation layer.

2. The air-permeable cushioning floor mat according to claim 1, wherein the surface layer comprises a carpet material.

3. The air-permeable cushioning floor mat according to claim 1, wherein the surface layer comprises a fabric material.

4. The air-permeable cushioning floor mat according to claim 1, wherein the surface layer is made of thermoplastic elastomer (TPE).

5. The air-permeable cushioning floor mat according to claim 1, wherein the surface layer is made of thermoplastic rubber (TPR).

6. The air-permeable cushioning floor mat according to claim 1, wherein the surface layer is made of polyvinyl chloride (PVC).

7. The air-permeable cushioning floor mat according to claim 1, wherein the anti-skid layer is a loop-and-hook type anti-skidding material comprising an upper knitted portion and rigid synthetic fiber yarns projecting therefrom.
